(19) United States
(12) Patent Application Publication
(10) Pub. No.: US 2016/0271928 A1
(43) Pub. Date: Sep. 22, 2016

(54) A METHOD FOR BONDING FIRST AND SECOND PANELS AND A DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei, Anhui (CN)

(72) Inventors: Hongqiang Luo, Beijing (CN); Zouming Xu, Beijing (CN); Wenjin Fan, Beijing (CN); Ting Zeng, Beijing (CN)

(21) Appl. No.: 14/777,591

(22) PCT Filed: Mar. 17, 2015
(86) PCT No.: PCT/CN15/74362

§ 371 Date: Sep. 16, 2015

(30) Foreign Application Priority Data
Oct. 28, 2014 (CN) 201410588272.8

(51) Int. Cl. B32B 37/14; B08B 7/00; B32B 7/12; B32B 37/12; B32B 38/10

(52) U.S. Cl. CPC B32B 37/142; B32B 37/12; B32B 38/10; B32B 7/12; B08B 7/0035; B32B 2305/72; B32B 2457/20; B32B 2405/00

(57) ABSTRACT

The invention provides a method for bonding a first panel and a second panel, the first panel and the second panel after bonded forming a display device or a portion of a display device, the surface area of the first panel being larger than the surface area of the second panel, therein, the method includes the following steps: a step of providing removable protecting strip on the periphery of the first panel, making the shape of an area surrounded by the protecting strip correspond to the shape of the second panel; a step of providing colourless transparent liquid glue in the area surrounded by the protecting strip; a step of bonding the first panel and the second panel; a step of curing the colourless transparent liquid glue; and a step of removing the protecting strip. The invention further provides a display device obtained by the above method. The display device or a portion of the display device obtained by the method provided by the invention does not appear the defects such as glue overflow etc.

### TECHNICAL FIELD

The invention refers to a technical field of assembling display device, and specifically to a method for bonding a first panel and a second panel and a display device obtained by the method.

### BACKGROUND

Many display devices (such as mobile phone, tablet computer, etc.) normally include a display panel and auxiliary panels such as a touch panel, protecting cover plate, etc. bonded on the display panel.

In prior art, normally following two methods are employed for bonding the auxiliary panels on the display panel: the first one is bonding the auxiliary panels on the display panel with solid transparent glue (i.e. transparent protecting strip), the disadvantage of which is air bubbles easily occur between the display panel and the auxiliary panels; the second one is boding the auxiliary panels on the display panel with transparent liquid glue, the disadvantage of which is the diffusion area of the transparent liquid glue is hard to control, so that product defect phenomena such as glue lacking, glue overflow, ripple etc. easily occur at periphery of the display device.

Therefore, how to prevent defect phenomena occur when bonding the display panel and the auxiliary panel becomes a technical problem to be solved in the field.

### SUMMARY

The object of the invention is providing a method for bonding a first panel and a second panel and a display device obtained by the method. The display device obtained by the above method has a relative high yield.

To realize the above object, as one aspect of the invention, the invention provides a method for bonding a first panel and a second panel. The first panel and the second panel after bonded form a display device or a portion of a display device, and the surface area of the first panel is larger than the surface area of the second panel. Therein, the method includes the following steps:

a step of providing removable protecting strip at the periphery of the first panel, making the shape of an area surrounded by the protecting strip correspond to the shape of the second panel;

a step of providing colourless transparent liquid glue in the area surrounded by the protecting strip;

a step of bonding the first panel and the second panel;

a step of curing the colourless transparent liquid glue; and

a step of removing the protecting strip.

Preferably, the step of providing removable protecting strip at the periphery of the first panel includes: providing a removable protecting strip on the edge portion of surface of the first panel.

Preferably, the first panel is a touch panel, and the second panel is a display module; or

The first panel is a display module, and the second panel is a touch panel; or

The first panel is a protecting cover plate, and the second panel is a liquid crystal box or a touch glass panel provided with touch sensors; or

The first panel is a liquid crystal box or a touch glass panel provided with touch sensors, and the second panel is a protecting cover plate.

Preferably, the volume of the colourless transparent liquid glue provided in the area surrounded by the protecting strip is larger than the volume of a cavity formed between the bonded first panel and second panel without filling the colourless transparent liquid glue.

Preferably, the second panel is a panel with four chamfers, a key is provided on the first panel, a groove is provided on a side of the second panel which corresponds to the key, and the shape of the inner edge of the groove is same or similar with the shape of the outer edge of the key.

Preferably, the colourless transparent liquid glue is provided in the area surrounded by the protecting strip by way of slit coating.

Preferably, the colourless transparent liquid glue is provided in the area surrounded by the protecting strip by way of dispensing.

Preferably, the method further includes a step executed between the step of providing colourless transparent liquid glue in the area surrounded by the protecting strip and the step of bonding the first panel and the second panel:

precuring the colourless transparent liquid glue.

Preferably, the method further includes a step executed after the step of bonding the first panel and the second panel:
defoaming the colourless transparent liquid glue.

Preferably, the step of removing the protecting strip is executed between the step of bonding the first panel and the second panel and the step of defoaming the colourless transparent liquid glue.

Preferably, the method further includes a step executed before the step of providing removable protecting strip on the periphery of the first panel:

cleaning the first panel and the second panel.

Preferably, the step of cleaning the first panel and the second panel includes: plasma cleaning the first panel and the second panel respectively.

Preferably, the first panel is a touch panel, and the second panel is a display module, the first panel including a first panel body and a black matrix provided on the edge portion of surface of the first panel body, the protecting strip being provided on the black matrix.

Preferably, in the step of providing removable protecting strip at the periphery of the first panel:

The protecting strip is peelable glue and is provided at the periphery of the first panel by way of printing; or

The protecting strip is adhesive tape, and is provided at the periphery of the first panel by way of affixing.

As another aspect of the invention, a display device is provided. Therein, the display device includes a first panel and a second panel bonded together with the method of the invention.

In the method provided by the invention, even if a phenomenon of glue overflow occurs in the step of providing the colourless transparent liquid glue in the area surrounded by the protecting strip, and/or a phenomenon of glue overflow occurs during bonding the first panel and the second panel, the overflowed glue would finally accumulate on the protecting strip which can be removed. Therefore, after curing the colourless transparent liquid glue to cohere the first panel and the second panel, the overflowed glue on the protecting strip will be removed while removing the protecting strip. It can be seen that, the defects such as glue overflow would not occur in the display device or a portion of the display device obtained by the method provided by the invention.

### BRIEF DESCRIPTION OF FIGURES

The attached figures are used for further understanding to the invention, and consist a portion of the description, and are used for explain the invention with the following detail embodiments, but do not limit the invention. In the figures:

FIG. 1 is a flow chart of the method for bonding a first panel and a second panel provided by the invention;

FIG. 2 is a front view of the first panel after provided with protecting strip;

FIG. 3 is a top view of the structure shown in FIG. 2;

FIG. 4 is a top view of the protecting strip in the structure shown in FIG. 2;

FIG. 5 is a top view of the structure shown in FIG. 3 after providing the colourless transparent liquid glue by way of slit coating;

FIG. 6 is a front view of the structure shown in FIG. 5;

FIG. 7 is a top view of the structure shown in FIG. 3 after providing the colourless transparent liquid glue by way of dispensing;

FIG. 8 is a front view of the structure shown in FIG. 7;

FIG. 9 is a front view of the structure formed by bonding the first panel and the second panel.

FIG. 10 is a front view of the display device or a portion of the display device formed after removing the protecting strip in the structure shown in FIG. 9;

FIG. 11 is a top view of the second panel; and

FIG. 12 is a top view of the display device or a portion of the display device shown in FIG. 10.

### LIST OF REFERENCE SIGNS

100: first panel; 110: first panel body;
120: black matrix; 210: protecting strip;
2201, 2002: colourless transparent liquid glue;
220′: colourless transparent liquid glue after cured;
300: second panel; 100a: key;
210a: projection.

### DETAIL EMBODIMENTS

Specific implementations of the invention will be further described in detail below in conjunction with the figures. It should be understood that, the specific implementations described here are used for illustrating the invention, rather than for limiting the scope of the invention.

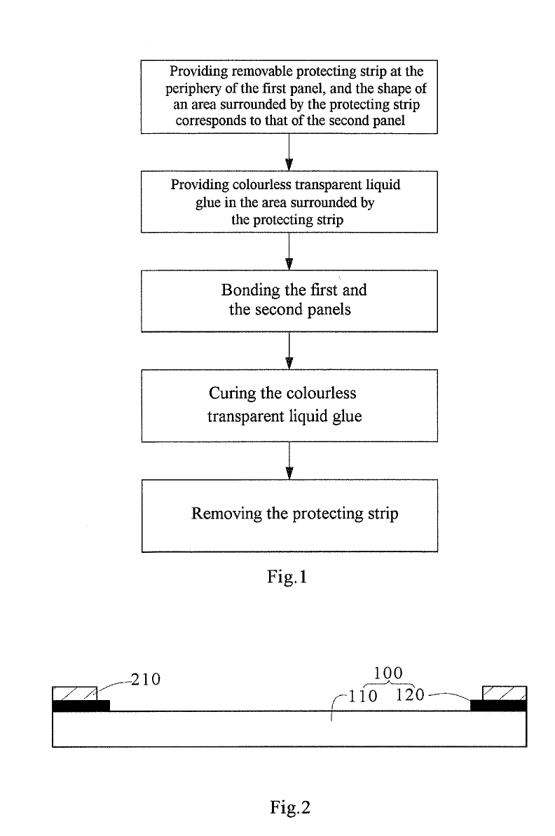

As shown in FIG. 1, as one aspect of the invention, the invention provides a method of bonding the first panel 100 and the second panel 300 (see FIG. 10), the bonded first panel and second panel 300 forming a display device or a portion of a display panel, and the surface area of the first panel 100 being larger than the surface area of the second panel 300, therein, the method includes the following steps:

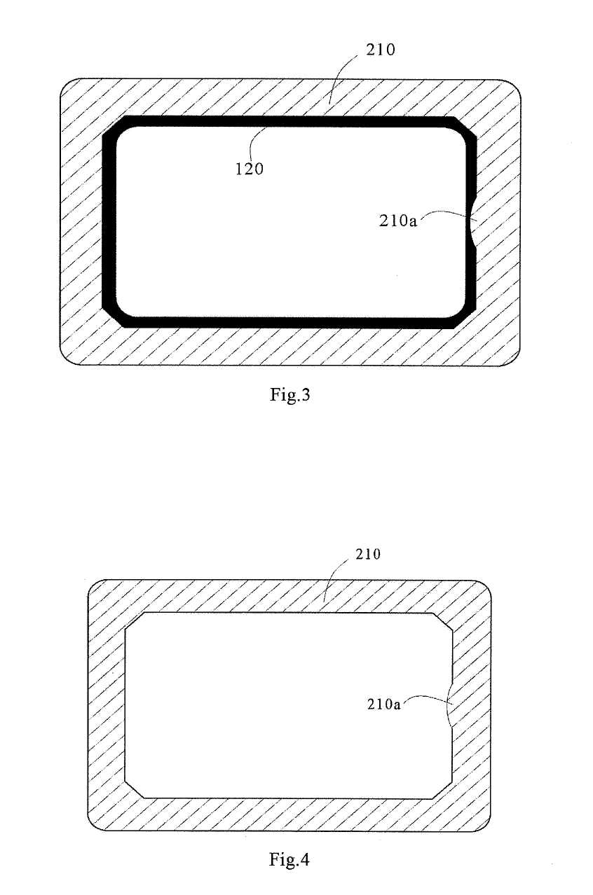

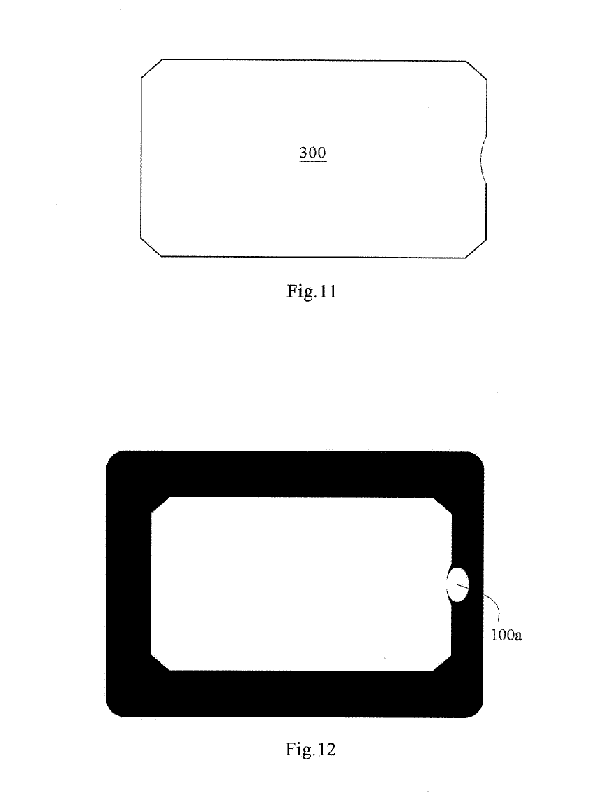

A step of providing removable protecting strip 210 at the periphery of the first panel 100; preferably, providing the removable protecting strip 210 on the edge portion of the first panel 100 (as shown in FIGS. 2 and 3), and the shape of an area surrounded by the protecting strip 210 corresponds to the shape of the second panel 300 (the shape of the protecting strip 210 is as shown in FIGS. 2 to 4, and the shape of the second panel 300 is as shown in FIG. 11);

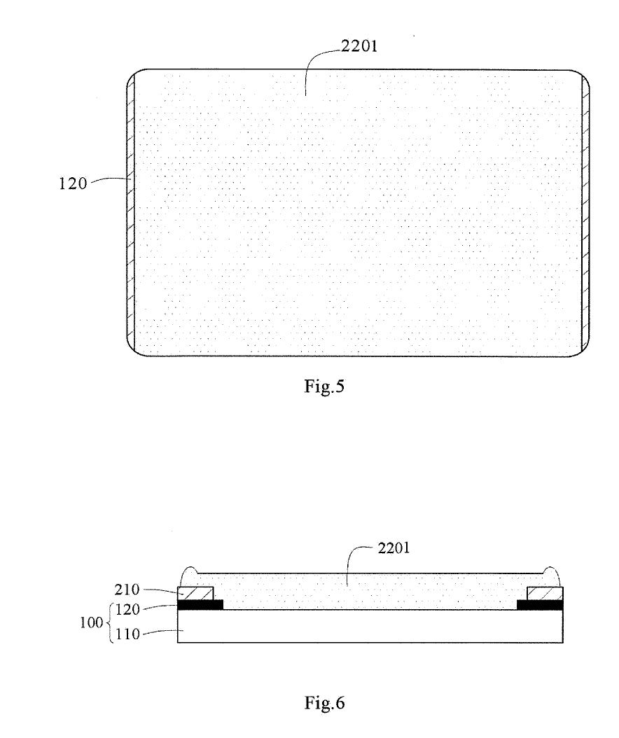

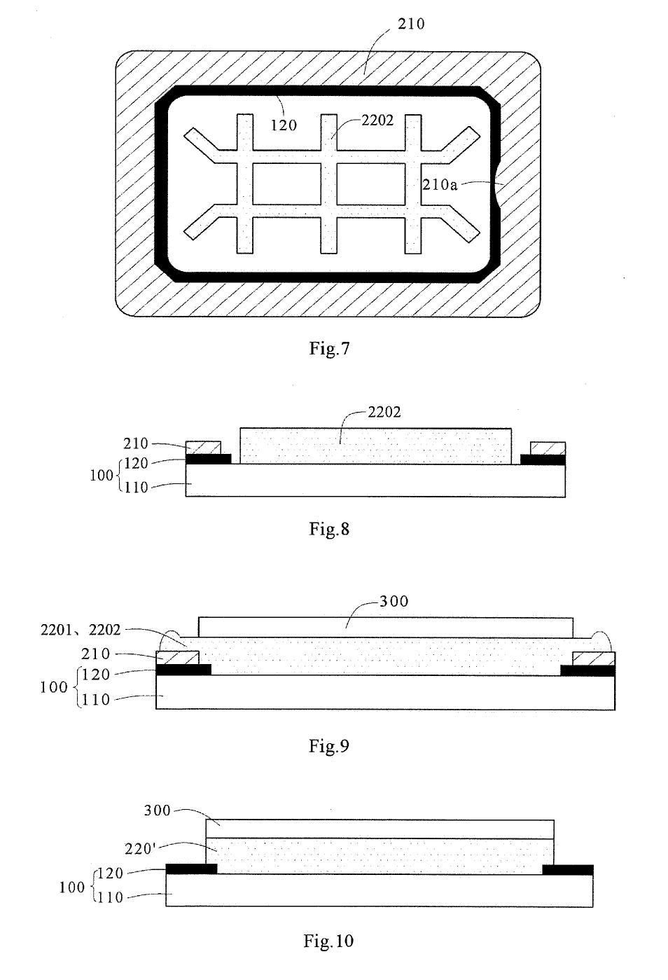

A step of providing colourless transparent liquid glue 2201 (as shown in FIGS. 5 and 6) or colourless transparent liquid glue 2202 (as shown in FIGS. 7 and 8) in the area surrounded by the protecting strip 210;

A step of bonding the first panel 100 and the second panel 300 (as shown in FIG. 9);

A step of curing the colourless transparent liquid glue 2201 or 2202; after curing the colourless transparent liquid glue 2201 or 2202, a cured colourless transparent liquid glue 220′ is formed between the first panel 100 and the second panel 300; and

A step of removing the protecting strip 210. The structure of the display device or a portion of the display device after the protecting strip 210 is removed is as shown in FIG. 10.

In the method provided by the invention, a phenomenon of glue overflow (as shown in FIG. 6) may occur in the step of providing the colourless transparent liquid glue in the area surrounded by the protecting strip, and a phenomenon of glue overflow (as shown in FIG. 9) also may occur during bonding the first panel 100 and the second panel 300, and the coulourless transparent liquid glue will overflow on the protecting strip 210 (as shown in FIGS. 6 and 9), since the protecting strip 210 is provided at the periphery of the colourless transparent liquid glue 2201 or 2202. After curing the colourless transparent liquid glue 2201 or 2202 to cohere the first panel 100 and the second panel 300, the overflowed glue on the protecting strip 210 can be removed while removing the protecting strip 210. It can be seen that, the defects such as glue overflow would not occur in the display device or a portion of the display device obtained by the method provided by the invention.

Moreover, in the invention, the first panel 100 and the second panel 300 are cohered to each other by the curing of the colourless transparent liquid glue 2201 or 2202, therefore there will not be air bubble between the first panel 100 and the second panel 300. It can be known that, the display device or a portion of the display device obtained by the method provided by the invention has a better optical performance.

In general, bonding the first panel and the second panel by the method provided by the invention can improve the yield of the display device or a portion of the display device obtained.

In the embodiment shown in the FIGS. 2 to 10, since the surface area of the first panel 100 is larger than that of the second panel 300, the protecting strip 210 is provided on the first panel 100, and the shape of the second panel 300 corresponds to the area surrounded by the protecting strip 210, therefore after bonding the first panel 100 and the second panel 300, the adherence performance between the second panel 300 and the first panel 100 would not be affected when the protecting strip 210 is removed.

In the invention, the bonded first panel 100 and second panel 300 form a display device or a portion of a display device. When the first panel 100 and the second panel 300 adhere together to form a display device, the first panel 100 can be a touch panel, and the second panel 300 can be a display module, or vice versa. When the first panel 100 and the second panel 300 adhere together to form a portion of a display device, the portion of the display device can be a display device or a touch panel, therefore, the first panel 100 can be a liquid crystal box or a touch glass panel with touch sensors, and the second panel 300 can be a protecting cover plate (such as glass cover plate), or vice verse.

In order to ensure the display device or a portion of the display device formed finally not have a defect of glue lack, preferably, the volume of the colourless transparent liquid glue 2201 or 2202 provided in the area surrounded by the protecting strip 210 is larger than the volume of a cavity formed between the bonded first panel 100 and second panel 300 without filling the colourless transparent liquid glue. That is, the amount of the colourless transparent liquid glue 2201 or 2202 provided is larger than the amount which the cavity formed between the bonded first panel 100 and second panel 300 without filling the colourless transparent liquid glue can receive. After providing the colourless transparent liquid glue 2201 or 2202, and bonding the first panel 100 and the second panel 300, the surplus colourless transparent liquid glue overflows from the cavity between the first panel 100 and the second panel 300 and accumulates on the protecting strip 210, so as to ensure the defect of lack glue not occur in the cavity between the first panel 100 and the second panel 300. When detaching the protecting strip 210, the overflowed glue accumulated on the protecting strip 210 can be removed together, and the defects such as folding wound not occur also.

As described above, the shape of the area surrounded by the protecting strip 210 corresponds to the shape of the second panel 300. Specifically, before providing the protecting strip 210 on the first panel 100, the protecting strip 210 can be pre-processed to make the protecting strip 210 have a predetermined shape, which can specifically make the shape of the area surrounded by the inner edge of the protecting strip 210 match with the shape of the outer contour of the second panel 300 after the protecting strip 210 is provided on the first panel 100.

In the invention, the first panel 100 and the second panel 300 can be rectangle panels of regular shape, be substantially rectangle panels of irregular shape, or can be other shape panels than the rectangle panels.

For example, as one embodiment of the invention, as shown in FIG. 11, the second panel 300 is a rectangle panel with four chamfers. As shown in FIG. 12, a key 100a is provided on the first panel 100, and after bonding the first panel 100 and the second panel 300, a groove is formed on a side of the second panel 300 which corresponds to the key 100a, and the shape of the inner edge of the groove is same or similar with the shape of the outer edge of the key 100a. Accordingly, as shown in FIGS. 4 and 11, the area surrounded by the inner edge of the protecting strip 210 have a same shape with the outer contour of the second panel 300, that is, a projection 210a which protrudes towards the center of the area surrounded by the protecting strip 210 is formed on the protecting strip 210.

In the invention, the specific way of providing the colourless transparent liquid glue 2201 or 2202 in the area surrounded by the protecting strip 210 is unlimited. For example, as one preferred embodiment of the invention, the colourless transparent liquid glue may be provided in the area surrounded by the protecting strip 210 by way of slit coating. As shown in FIG. 5, with the way of slit coating, the area surrounded by the protecting strip 210 can be filled with the colourless transparent liquid glue 2201. The thickness of the colourless transparent liquid glue 2201 can be uniform by way of slit coating, and the slit coating has higher efficiency.

Of course, the invention is not limited by this. For example, the colourless transparent liquid glue may be provided in the area surrounded by the protecting strip 210 by way of dispensing. As shown in FIGS. 7 and 8, the colourless transparent liquid glue may be disposed at partial positions in the area surrounded by the protecting strip 210 by way of dispensing.

Of course, the invention is not limited by this. For example, the colourless transparent liquid glue may be provided in the area surrounded by the protecting strip 210 by way of screen printing.

For facilitating alignment between the first panel 100 and the second panel 300, preferably, the method further includes a step executed between the step of providing colourless transparent liquid glue in the area surrounded by the protecting strip and the step of bonding the first panel and the second panel: precuring the colourless transparent liquid glue.

The ways of precuring the colourless transparent liquid glue include many ways, which can be chosen according to curing mechanism of the colourless transparent liquid glue. For example, when the colourless transparent liquid glue is photocuring glue, the colourless transparent liquid glue can be precured by way of illumination; when the colourless transparent liquid glue is thermocuring glue, the colourless transparent liquid glue can be precured by way of heating. Since the half-cured colourless transparent liquid glue would not flow arbitrarily, the half-cured colourless transparent liquid glue would not stick to the second panel 300 when aligning the first panel 100 and the second panel 300, so that adjusting of the position of the second panel 300 would not be affected, which facilitates ensuring the accuracy alignment between the first panel 100 and the second panel 300.

For further avoiding air bubble generating between the first panel 100 and the second panel 300, preferably, the method further includes a step executed after the step of bonding the first panel and the second panel: defoaming the colourless transparent liquid glue. Specifically, the first panel 100 and the second panel 300 bonded together can be put into defoaming furnace to be heated and pressured, so as to eliminate residual air between the second panel 300 and the colourless transparent liquid glue when bonding the first panel 100 and the second panel 300.

In the invention, the order of the various steps is not limited strictly, and the actual order of the various steps can be determined by the implementer according to specific product requirement and production practice. For example, the above defoaming step may be executed between the step of bonding the first panel 100 and the second panel 300 and the step of curing the colourless transparent liquid glue, may be executed between the step of curing the colourless transparent liquid glue and the step of removing the protecting strip 210, or may be executed after removing the protecting strip 210. The step of removing the protecting strip 210 is only needed to be executed after the step of bonding the first panel 100 and the second panel 300. In order to further ensure there being not edge defect after curing the colourless transparent liquid glue, preferably, the step of removing the protecting strip 210 can be executed after the step of precuring the colourless transparent liquid glue. This is because after precuring the colourless transparent liquid glue, the colourless transparent liquid glue can't flow arbitrarily, so that after removing the protecting strip 210, the defects such as ripple etc. would not occur around the colourless transparent liquid glue half-cured. As a further preferable embodiment of the invention, the step of removing the protecting strip 210 can be executed between the step of bonding the first panel 100 and the second panel 300 and the step of defoaming the colourless transparent liquid glue, since during bonding the first panel 100 and the second panel 300, the colourless transparent liquid glue may overflow, and during defoaming, is needed to be pressured and heated, which may cause the protecting strip 210 be damaged.

In order to ensure the first panel 100 and the second panel 300 adhere together securely, preferably, the method further includes a step executed before providing the protecting strip 210 on the first panel 100: cleaning the first panel 100 and the second panel 300. For example, the first panel 100 and the second panel 300 can be plasma cleaned, to clear up the impurity particles on the first panel 100 and the second panel 300.

As a specific embodiment of the invention, the first panel 100 may be a touch panel, and the second panel 300 may be a display module, and as the first panel is a touch panel, as shown in FIGS. 2 and 3, the first panel 100 may include a first panel body 110 and a black matrix 120 provided around the edge portion of the surface of the first panel body 110, and the protecting strip 210 can be provided on the black matrix 120. It can be easily understood, the first panel body 110 is provided with touch sensors, and the black matrix 120 is used for covering the leads of the touch sensors.

In the invention, the material of the protecting strip, the specific way of providing the protecting strip and the specific forming way of the protecting strip are not limited especially.

For example, as one specific embodiment of the invention, the protecting strip can be made by peelable ink, and in the step of providing removable protecting strip at the periphery of the first panel, the protecting strip may be formed by way of printing.

As another example and another specific embodiment of the invention, the protecting strip may be adhesive tape, and in the step of providing removable protecting strip at the periphery of the first panel, the protecting strip may be formed by affixing.

As another aspect of the invention, a display device obtained by the method provided by the invention is provided, which includes a first panel and a second panel bonded together by the method provided by the invention.

In the method provided by the invention, even if a phenomenon of glue overflow occurs in the step of providing the colourless transparent liquid glue in the area surrounded by the protecting strip, and/or a phenomenon of glue overflow occurs during bonding the first panel and the second panel, the overflowed glue would finally accumulate on the protecting strip which can be removed. Therefore, after curing the colourless transparent liquid glue to cohere the first panel and the second panel, the overflowed glue on the protecting strip will be removed while removing the protecting strip. It can be seen that, the defects such as glue overflow would not occur in the display device or a portion of the display device obtained by the method provided by the invention.

It should be understood that, the above embodiments are only example embodiments used for illustrating the principle of the invention, but the invention is not limited by this. For those skilled in the art, without departing from the spirit and essence of the invention, various changes and improvements can be made, which belong to the protection scope of the invention as well.

What is claimed is:

1-15. (canceled)

16. A method for bonding a first panel and a second panel to form at least a portion of a display device, the surface area of the first panel being larger than the surface area of the second panel, the method comprising:
providing a removable protecting strip at a periphery of the first panel, the protecting strip surrounding an area corresponding to the shape of the second panel;
providing colorless transparent liquid glue in the area surrounded by the protecting strip;
bonding the first panel and the second panel;
curing the colorless transparent liquid glue; and
removing the protecting strip.

17. The method according to claim 16, wherein the removable protecting strip is provided on an edge portion of a surface of the first panel.

18. The method according to claim 16, wherein:
one of the first and second panels comprises a display module; and
the other of the first and second panels comprises a touch panel.

19. The method according to claim 16, wherein the volume of the colorless transparent liquid glue provided in the area surrounded by the protecting strip is larger than the volume of a cavity formed between the first panel and the second panel when the first and second panels are in an assembled condition without the colorless transparent liquid glue.

20. The method according to claim 16, wherein:
the second panel comprises is a panel with four chamfers;
a key is provided on the first panel;
a groove is provided on a side of the second panel which corresponds to the key; and
the shape of the inner edge of the groove is same or similar with the shape of the outer edge of the key.

21. The method according to claim 19, wherein the colorless transparent liquid glue is provided by way of slit coating.

22. The method according to claim 19, wherein the colorless transparent liquid glue is provided by way of dispensing.

23. The method according to claim 16, further comprising:
precuring the colorless transparent liquid glue;
wherein precuring the colorless transparent liquid glue is performed after providing the colorless transparent liquid glue and before bonding the first panel and the second panel.

24. The method according to claim 16, further comprising:
defoaming the colorless transparent liquid glue;
wherein defoaming the colorless transparent liquid glue is performed after bonding the first panel and the second panel.

25. The method according to claim 24, further comprising:
removing the protecting strip;
wherein removing the protecting strip is performed after bonding the first panel and the second panel and before defoaming the colorless transparent liquid glue.

26. The method according to claim 16, further comprising:
cleaning the first panel and the second panel;
wherein cleaning the first panel and the second panel is performed before removing the protecting strip.

27. The method according to claim 26, wherein cleaning the first panel and the second panel comprises plasma cleaning the first and second panels.

28. The method according to claim 16, wherein:
the first panel comprises a touch panel;
the second panel comprises a display module;
the first panel includes:
a first panel body having an edge portion; and
a black matrix on the edge portion;
the protecting strip is provided on the black matrix.

29. The method according to claim 16, wherein:
the protecting strip is a peelable glue and is provided at the periphery of the first panel by way of printing; or
the protecting strip is a adhesive tape, and is provided at the periphery of the first panel by way of affixing.

30. A display device comprising:
a first panel;
a second panel; and
a transparent liquid glue bonding the first panel to the second panel;
wherein the surface area of the first panel is greater than the surface area of the second panel;
wherein a protecting strip is disposed at the periphery of the first panel, the protecting strip surrounding an area that corresponds to the shape of the second panel; and
wherein the protective strip may be removed after the transparent liquid glue has cured.

31. The method according to claim 16, wherein:
one of the first and second panels comprises a protecting cover plate; and
the other of the first and second panels comprises a touch glass panel with touch sensors.

32. The method according to claim 16, wherein the protecting strip is adhesive tape that is attached to the periphery of the first panel by way of affixing.
